(19) United States
(12) Patent Application Publication
(10) Pub. No.: US 2026/0050387 A1
(43) Pub. Date: Feb. 19, 2026

(54) DYNAMIC INITIALIZATION DELAY MANAGEMENT FOR A MEMORY SYSTEM

(71) Applicant: Micron Technology, Inc., Boise, ID (US)

(72) Inventors: Wenjun Wu, Shanghai (CN); Deping He, Boise, ID (US); Jianfeng Li, Shanghai (CN)

(21) Appl. No.: 19/277,095

(22) Filed: Jul. 22, 2025

Related U.S. Application Data
(60) Provisional application No. 63/683,085, filed on Aug. 14, 2024.

(51) Int. Cl. G06F 3/06

(52) U.S. Cl. CPC G06F 3/0632; G06F 3/0611; G06F 3/0634; G06F 3/0679

(57) ABSTRACT

Methods, systems, and devices for dynamic initialization delay management for a memory system are described. A memory system may perform a power transition operation from a hibernation mode to an active mode in response to a command from a host system. The memory system and host system may refrain from communicating signaling during the power transition operation due to power transition delays. A memory system power transition delay may be dynamically configured based on a host system power transition delay, such that the memory system power transition delay may be initially programmed then updated based on receiving an indication of the host system power transition delay. The host system may transmit the indication of the host system power transition delay during an initial linking operation with the memory system. The memory system may update the memory system power transition delay to be greater than the host system power transition delay.

### CROSS REFERENCE

The present Application for Patent claims priority to U.S. Patent Application No. 63/683,085 by Wu et al., entitled “DYNAMIC INITIALIZATION DELAY MANAGEMENT FOR A MEMORY SYSTEM,” filed Aug. 14, 2024, which is assigned to the assignee hereof, and which is expressly incorporated by reference in its entirety herein.

### TECHNICAL FIELD

The following relates to one or more systems for memory, including dynamic initialization delay management for a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports dynamic initialization delay management for a memory system in accordance with examples as disclosed herein.

FIG. 2 shows an example of a process flow timing diagram that supports dynamic initialization delay management for a memory system in accordance with examples as disclosed herein.

FIG. 3 shows a block diagram of a memory system that supports dynamic initialization delay management for a memory system in accordance with examples as disclosed herein.

FIG. 4 shows a flowchart illustrating a method or methods that support dynamic initialization delay management for a memory system in accordance with examples as disclosed herein.

### DETAILED DESCRIPTION

In some systems, a memory system and a host system may communicate to facilitate different types of power transition operations between various power modes. For example, the memory system may be configured to perform a power transition operation (e.g., a hibernate exit operation) in which the memory system transitions from a hibernation mode (e.g., a low power mode) to an active mode (e.g., a high power mode). In some cases, during the power transition operation, the memory system and the host system may be configured to become active (e.g., capable of communication, configured to transmit signaling) at least partially concurrently, which may cause signaling between the memory system and the host system to occur during a same duration. In some such cases, the memory system and the host system may be configured to communicate such signaling via one or more same communication channels (e.g., interfaces, buses) between the memory system and the host system, such that signaling during a same duration may cause interference (e.g., cross-talk) and/or noise over the one or more same communication channels. In some examples, the interference and/or noise may cause decreased reliability and performance during communication between the memory system and the host system.

In some cases, the memory system and the host system may each be configured to become active at least partially concurrently based on the memory system and the host system being programmed with similar power transition delays (e.g., tActivation times). For example, during the power transition operation, the memory system may be configured to refrain from signaling for the memory system power transition delay (e.g., memory system tActivation), and the host system may be configured to refrain from signaling for the host system power transition delay (e.g., host system tActivation). However, the memory system power transition delay and the host system power transition delay may be similar in duration, such that memory system and the host system may be configured to begin transmitting signaling during the same duration. In some cases, the memory system power transition delay and the host system power transition delay may be programmed such that the values of which are sufficiently different in duration to avoid interference and/or noise, however this may cause unnecessary latency for performing access operations following the power transition operation.

In accordance with examples as described herein, the memory system power transition delay may be dynamically configured based on the host system power transition delay. For example, the memory system power transition delay may be initially programmed as a relatively long duration (e.g., duration of greatest expected host system power transition delay). In some such examples, during an initial linking operation (e.g., establishing a connection between the memory system and the host system), the host system may transmit an indication of the host system power transition delay to the memory system. The memory system may update the memory system power transition delay based on the indication of the host system power transition delay, such that the memory system power transition delay is greater (e.g., incrementally greater) than the host system power transition delay. After updating the memory system power transition delay, the memory system may store an indication of the memory system power transition delay, such that during the power transition operation, the memory system may use the updated memory system power transition delay. Implementing the dynamically configured power transition delay may prevent interference and/or noise over the same communication channels without causing unnecessary latency otherwise associated with pre-programming the memory system power transition delay (e.g., such that the value of which is sufficiently different in duration to avoid interference and/or noise).

In addition to applicability in memory systems as described herein, techniques for dynamic initialization delay management for a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by preventing interference and/or noise over shared communication channels between a memory system and a host system after a power transition operation, which may improve reliability of the electronic devices, among other benefits.

In addition to applicability in memory systems as described herein, techniques for dynamic initialization delay management for a memory system may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by preventing interference and/or noise over shared communication channels between a memory system and a host system after a power transition operation, which may improve data transfer between devices, among other benefits.

Features of the disclosure are illustrated and described in the context of systems, devices, and circuits. Features of the disclosure are further illustrated and described in the context of a process flow timing diagram and a flowchart.

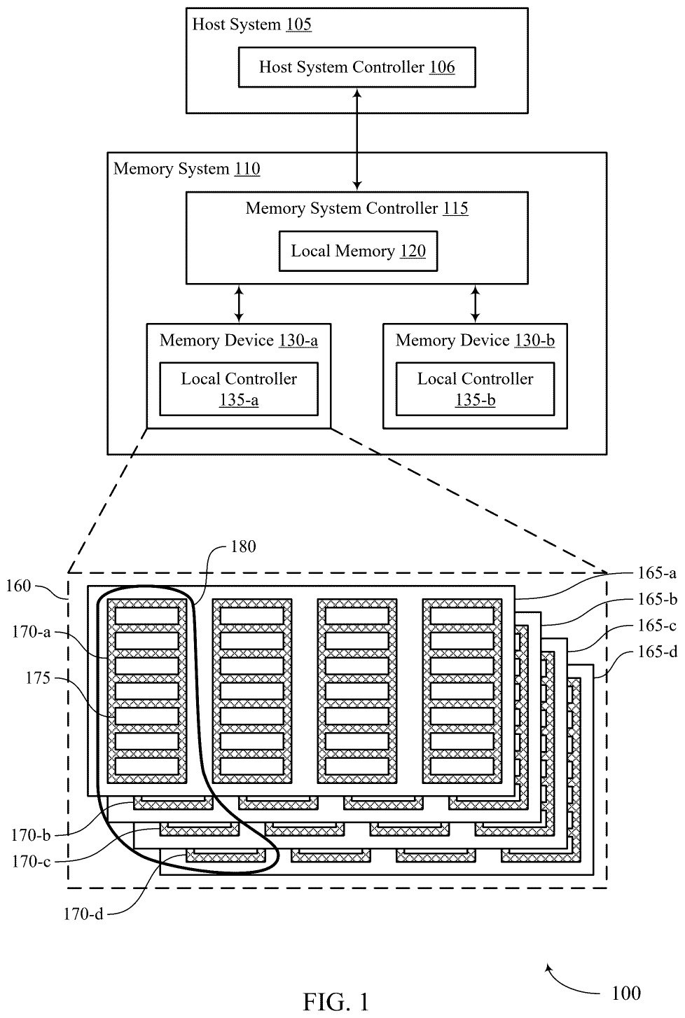

FIG. 1 shows an example of a system 100 that supports dynamic initialization delay management for a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some cases, the memory system 110 and the host system 105 may communicate to facilitate different types of power transition operations between various power modes. For example, the memory system 110 may be configured to perform a power transition operation (e.g., a hibernate exit operation) in which the memory system 110 transitions from a hibernation mode (e.g., a low power mode) to an active mode (e.g., a high power mode). In some cases, during the power transition operation, the memory system 110 and the host system 105 may be configured to become active such that the memory system 110 and the host system 105 are capable of communicating signaling via one or more same communication channels (e.g., interfaces, buses). In some cases, the memory system 110 and the host system 105 may each be configured to become active based on the memory system 110 and the host system 105 being programmed with power transition delays (e.g., tActivation times). For example, during the power transition operation, the memory system 110 may be configured to refrain from signaling for the memory system power transition delay (e.g., memory system tActivation), and the host system 105 may be configured to refrain from signaling for the host system power transition delay (e.g., host system tActivation).

In accordance with examples as described herein, the memory system power transition delay may be dynamically configured based on the host system power transition delay. For example, the memory system power transition delay may be initially programmed as a relatively long duration (e.g., duration of greatest expected host system power transition delay). In some such examples, during an initial linking operation (e.g., establishing a connection between the memory system 110 and the host system 105), the host system 105 may transmit an indication of the host system power transition delay to the memory system 110. The memory system 110 may update the memory system power transition delay based on the indication of the host system power transition delay, such that the memory system power transition delay is greater (e.g., incrementally greater) than the host system power transition delay. After updating the memory system power transition delay, the memory system 110 may store an indication of the memory system power transition delay, such that during the power transition operation, the memory system 110 may use the updated memory system power transition delay. Implementing the dynamically configured power transition delay may prevent interference and/or noise over the same communication channels without causing unnecessary latency otherwise associated with pre-programming the memory system power transition delay (e.g., such that the value of which is sufficiently different in duration to avoid interference and/or noise).

The system 100 may include any quantity of non-transitory computer readable media that support dynamic initialization delay management for a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

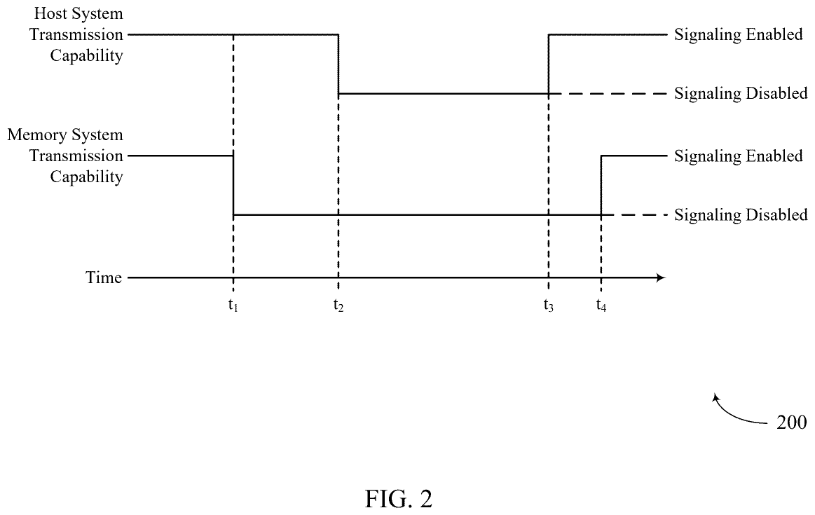

FIG. 2 shows an example of a process flow timing diagram 200 that supports dynamic initialization delay management for a memory system in accordance with examples as disclosed herein. The process flow timing diagram 200 may implement aspects of or be implemented by a system, which may be an example of a system 100, as described with reference to FIG. 1. For example, the process flow timing diagram 200 may illustrate operations of a host system and a memory system, which may be examples of a host system 105 and a memory system 110, respectively, as described with reference to FIG. 1. The process flow timing diagram 200 illustrates signaling capabilities of the host system and the memory system during various power transition operations.

The process flow timing diagram 200 illustrates durations over which the host system and the memory system may be configured to transmit signaling to one another. That is, the process flow timing diagram 200 illustrates host system transmission capability relative to time, such that at some durations the host system may be configured to transmit signaling (e.g., signaling enabled) to the memory system and at other durations the host system may not be configured to transmit signaling (e.g., signaling disabled) to the memory system. Likewise, the process flow timing diagram 200 illustrates memory system transmission capability relative to time, such that at some durations the memory system may be configured to transmit signaling (e.g., signaling enabled) to the host system and at other durations the memory system may not be configured to transmit signaling (e.g., signaling disabled) to the host system. For example, the host system transmission capability may be illustrative of a transmission line (e.g., a transmission driver) of the host system, and the memory system transmission capability may be illustrative of a transmission line (e.g., a transmission driver) of the memory system. Though not illustrated (e.g., for clarity), the host system may also be associated with a host system reception capability which may be indicative of a reception line (e.g., receiver) of the host system. Likewise, though not illustrated (e.g., for clarity), the memory system may also be associated with a memory system reception capability which may be indicative of a reception line (e.g., receiver) of the memory system. In some examples, the host system and the memory system may be configured to communicate signaling via one or more shared communication channels, which may be examples of interfaces or buses between the host system and the memory system. In some such examples, when the signaling is enabled for the host system and/or when the signaling is enabled for the memory system, the signaling may be transmitted over the one or more shared communication channels.

The host system and the memory system may be configured to perform various power transition operations. For example, the memory system may be configured to perform different types of power transition operations. That is, the memory system may be configured to transition between various power modes based on signaling from the host system. For example, the memory system may be configured to perform a hibernation operation (e.g., a type of power transition operation), in which the memory system transitions from an active mode to a hibernation mode. In some such examples, the active mode may be a high power mode, in which the memory system may be configured to transmit and receive signaling (e.g., commands, indications) with the host system, as well as perform internal memory operations (e.g., access operations, management operations). Conversely, the hibernation mode may be a low power mode, in which the memory system may not be configured to communicate signaling with the host system or perform internal memory operations. In some cases, the memory system may be configured to perform a hibernation exit operation (e.g., another type of power transition operation), in which the memory system transitions from the hibernation mode to the active mode. In some examples, the memory system may be configured to perform the power transition operations (e.g., hibernation operation, hibernation exit operation) based on commands received from the host system. For example, the memory system may perform the hibernation operation based on receiving a command (e.g., a hibernate command) from the host system, and the memory system may perform the hibernation exit operation based on receiving a command (e.g., a hibernate exit command) from the host system.

In some cases, during a hibernation exit operation, the memory system may be configured to transition from the hibernation mode to the active mode over a duration associated with activating various components of the memory system. In some such cases, the memory system and the host system may refrain from communicating signaling during the duration in which the memory system is transitioning from the hibernation mode to the active mode. In some examples, the duration in which the memory system is transitioning from the hibernation mode to the active mode may be associated with power transition delays of the memory system and the host system. That is, the memory system and the host system may refrain from communicating the signaling based on power transition delays, which may be examples of tActivation times. For example, the memory system may refrain from transmitting signaling to the host system during a memory system power transition delay (e.g., a memory system tActivation time), which may generally correspond to the duration in which the memory system is transitioning from the hibernation mode to the active mode. Likewise, the host system may refrain from transmitting signaling to the memory system during a host system power transition delay (e.g., a host system tActivation time), which may generally be associated with the duration in which the memory system is transitioning from the hibernation mode to the active mode.

In some cases, the power transition delays may be at least partially preconfigured prior to operation. That is, the memory system may be programmed with the memory system power transition delay and the host system may be programmed with the host system power transition delay during a manufacturing phase of the system life (e.g., prior to an operational phase, prior to an initial linking operation between the memory system and the host system). In some such cases, the memory system power transition delay may be stored as an indication in a register of the memory system, or as data in a non-volatile memory or a read-only memory of the memory system. Likewise, the host system power transition delay may be stored in a register, a non-volatile memory, a read-only memory, or firmware of the host system. In some cases, the memory system power transition delay may be preconfigured as a relatively long duration. For example, the memory system power transition delay may be initially configured to have a duration greater than or equal to a host system power transition delay. That is, each host system power transition delay may be different depending on a manufacturer of the host system, and can be preconfigured based on the manufacturer. Thus, the memory system power transition delay may be greater than or equal to a greatest expected host system power transition delay based on the various known host system power transition delays.

The memory system power transition delay may be dynamically configured after it is preconfigured. For example, the memory system power transition delay may be dynamically configured based on the host system power transition delay. That is, the memory system power transition delay may be dynamically configured to be greater than the host system power transition delay by a threshold duration (e.g., a threshold difference between the memory system transition delay and the host system power transition delay). In some examples, the memory system transition delay may be greater than the threshold duration in addition to the host system power transition delay, and the memory system transition delay may be decreased such that the memory system transition delay satisfies the threshold duration. In other examples, the memory system transition delay may be less than the threshold duration in addition to the host system power transition delay, and the memory system transition delay may be increased such that the memory system power transition delay satisfies the threshold duration. For example, if the memory system power transition delay is 150 μs, the host system power transition delay is 100 μs, and the threshold duration is 100 μs, then the memory system power transition delay may be dynamically configured (e.g., updated, increased) to be 200 μs (e.g., due to the memory system power transition delay having to satisfy the threshold duration combined with the host system power transition delay). However, if the memory system power transition delay is 200 μs, the host system power transition delay is 100 μs, and the threshold duration is 50 μs, then the memory system power transition delay may be dynamically configured (e.g., updated, decreased) to be 150 μs.

In some cases, the memory system may update the memory system power transition delay as part of an initial linking operation. That is, the memory system and the host system may perform an initial linking operation (e.g., after manufacturing the memory system and the host system) to establish a connection between the memory system and the host system. In some cases, the linking operation may include communicating signaling between the memory system and the host system to establish the connection and set operating parameters for the memory system and the host system. In some such cases, the host system may transmit an indication of the host system power transition delay to the memory system during the linking operation (e.g., as part of the signaling to establish the connection). The memory system may use the host system power transition delay to dynamically configure the memory system power transition delay. After updating the memory system power transition delay, the memory system may store an indication of the memory system power transition delay to a register, a non-volatile memory, or a read-only memory of the memory system. After performing the initial linking operation and storing the indication of the memory system power transition delay, the memory system may use the memory system power transition delay while performing the hibernation exit operation.

The process flow timing diagram 200 illustrates the host system and the memory system performing a hibernation operation and a hibernation exit operation after performing the initial linking operation (e.g., not shown). Firstly, prior to t1, the memory system may be operating in an active mode, such that the host system and the memory system may each be operating (e.g., normally) and capable of transmission. That is, signaling may be enabled for both the host system and the memory system during this duration. At t1, the host system may transmit a hibernate command to the memory system. After receiving the hibernate command, the memory system may perform the hibernation operation, in which the memory system transitions from the active mode to the hibernation mode. After entering the hibernation mode (e.g., at least until t2), the memory system may be incapable of transmission and signaling may be disabled. However, after the memory system enters the hibernation mode (e.g., at least until t2), the host system may remain capable of transmission and signaling may be enabled. In some cases, the memory system may remain capable of signal reception after t1.

Secondly, at t2, the host system may transmit a hibernate exit command to the memory system. After receiving the hibernate exit command, the memory system may perform the hibernation exit operation, in which the memory system transitions from the hibernation mode to the active mode. While performing the hibernation exit operation, the memory system may activate various components of the memory system, initiate internal power-up (e.g., start-up) processes, or increase power consumption, or any combination thereof. After receiving the hibernate exit command, the memory system power transition delay may be initiated, such that the memory system may be incapable of transmission and signaling may be disabled for the duration of the memory system power transition delay. The memory system power transition delay may occur from t2 to t4 of the process flow timing diagram. After transmitting the hibernate exit command, the host system power transition delay may be initiated, such that the host system may be incapable of transmission and signaling may be disabled for the duration of the host system power transition delay. The host system power transition delay may occur from t2 to t3 of the process flow timing diagram 200. In some cases, the host system and the memory system may remain capable of signal reception after t2.

Thirdly, at t3, the host system power transition delay may be completed. After completing the host system power transition delay, the host system may be capable of transmission and signaling may be enabled. The host system may begin transmitting signaling to the memory system after completing the host system power transition delay. For example, the host system may begin transmitting access commands, such as read commands and write commands, to the memory system. However, at t3, the memory system power transition delay may not be completed. That is, because the memory system power transition delay is dynamically configured to be greater than the host system power transition delay, the memory system may remain incapable of transmission and signaling may be disabled. However, for the duration between t3 and t4, although the memory system may not be configured to transmit signaling to the host system, the host system may be configured to transmit signaling to the memory system. In some cases, the hibernation exit operation may be completed yet the memory system power transition delay may remain. In some such cases, the memory system may be functionally active, yet the memory system may refrain from transmitting signaling with the host system. In some cases, the memory system may remain capable of signal reception after t3.

Finally, at t4, the memory system power transition delay may be completed. After completing the memory system power transition delay, the memory system may be capable of transmission and signaling may be enabled. The memory system may begin transmitting signaling to the host system after completing the memory system power transition delay. For example, the memory system may begin transmitting access command responses, such as read command responses and write command responses, to the host system. After t4, the memory system and the host system may both be capable of transmission and configured to support transmitting signaling via the one or more shared communication channels.

In accordance with examples as described herein, the memory system may be configured to support dynamically configuring the memory system power transmission delay based on the host system power transmission delay. Dynamically configuring the memory system power transmission delay to be greater than the host system power transmission delay may prevent the host system and the memory system from becoming capable of transmission concurrently, which may prevent interference associated with concurrent signaling between the host system and the memory system. That is, by allowing the host system to become capable of transmission prior to the memory system, signaling may be communicated in stages between the host system and the memory system, thereby preventing noise otherwise associated with transmitting signaling concurrently over the one or more shared communication channels. Accordingly, the memory system may support decreased interference and noise without increasing latency for performing access operations otherwise associated with preconfiguring the power transmission delay without dynamic configuration support.

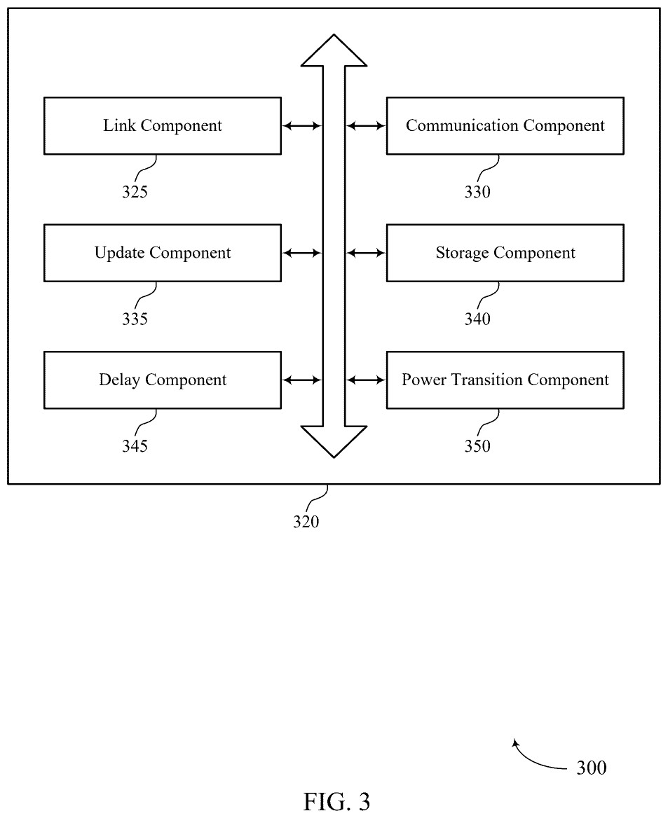

FIG. 3 shows a block diagram 300 of a memory system 320 that supports dynamic initialization delay management for a memory system in accordance with examples as disclosed herein. The memory system 320 may be an example of aspects of a memory system as described with reference to FIGS. 1 through 2. The memory system 320, or various components thereof, may be an example of means for performing various aspects of dynamic initialization delay management for a memory system as described herein. For example, the memory system 320 may include a link component 325, a communication component 330, an update component 335, a storage component 340, a delay component 345, a power transition component 350, or any combination thereof. Each of these components, or components of subcomponents thereof (e.g., one or more processors, one or more memories), may communicate, directly or indirectly, with one another (e.g., via one or more buses).

The link component 325 may be configured as or otherwise support a means for performing a link operation between the memory system and a host system, where, prior to the link operation, the memory system is configured to perform a type of power transition operation in accordance with a first delay. The communication component 330 may be configured as or otherwise support a means for receiving, in association with the link operation, an indication of a second delay associated with the host system performing the type of power transition operation. The update component 335 may be configured as or otherwise support a means for updating, in response to receiving the indication of the second delay associated with the host system, the memory system to perform the type of power transition operation in accordance with a third delay that is greater than the second delay.

In some examples, the storage component 340 may be configured as or otherwise support a means for storing an indication of the third delay in non-volatile memory of the memory system in response to updating the memory system to perform the type of power transition operation in accordance with the third delay.

In some examples, the communication component 330 may be configured as or otherwise support a means for receiving, from the host system, a command to perform a power transition operation of the type of power transition operation. In some examples, the delay component 345 may be configured as or otherwise support a means for initiating the third delay in response to the command to perform the power transition operation. In some examples, the power transition component 350 may be configured as or otherwise support a means for transitioning, in response to receiving the command to perform the power transition operation, the memory system from a first power mode to a second power mode.

In some examples, the second delay is in response to the command to perform the power transition operation.

In some examples, the communication component 330 may be configured as or otherwise support a means for communicating, by the memory system, signaling with the host system after the third delay has elapsed.

In some examples, signaling, from the host system, is received by the memory system after the second delay has elapsed.

In some examples, the second delay is associated with a duration for which the host system refrains from communicating signaling with the memory system while performing the type of power transition operation, and the third delay is associated with a duration for which the memory system refrains from communicating signaling with the host system while performing the type of power transition operation.

In some examples, to support performing the link operation, the communication component 330 may be configured as or otherwise support a means for communicating signaling indicating operational parameters between the memory system and the host system, where receiving the indication of the second delay is in accordance with communicating the signaling.

In some examples, to support performing the link operation, the link component 325 may be configured as or otherwise support a means for establishing an initial connection between the memory system and the host system, where communicating the signaling is in response to establishing the initial connection.

In some examples, the first delay is greater than or equal to the second delay. In some examples, the third delay is smaller than the first delay.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

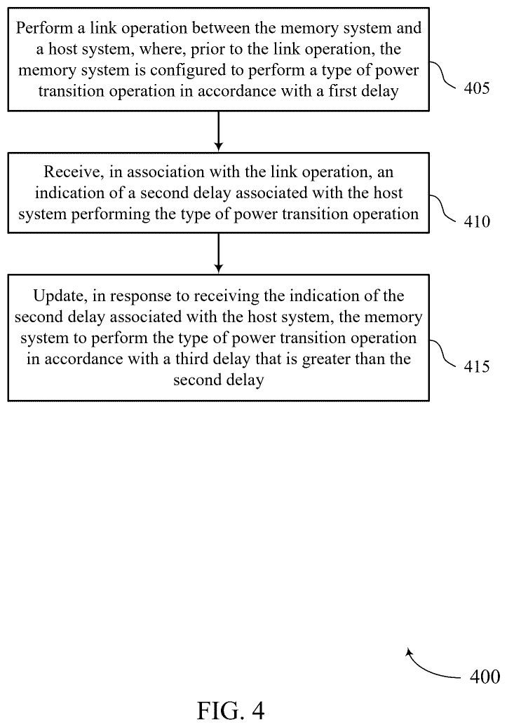

FIG. 4 shows a flowchart illustrating a method 400 that supports dynamic initialization delay management for a memory system in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include performing a link operation between the memory system and a host system, where, prior to the link operation, the memory system is configured to perform a type of power transition operation in accordance with a first delay. In some examples, aspects of the operations of 405 may be performed by a link component 325 as described with reference to FIG. 3.

At 410, the method may include receiving, in association with the link operation, an indication of a second delay associated with the host system performing the type of power transition operation. In some examples, aspects of the operations of 410 may be performed by a communication component 330 as described with reference to FIG. 3.

At 415, the method may include updating, in response to receiving the indication of the second delay associated with the host system, the memory system to perform the type of power transition operation in accordance with a third delay that is greater than the second delay. In some examples, aspects of the operations of 415 may be performed by an update component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for performing a link operation between the memory system and a host system, where, prior to the link operation, the memory system is configured to perform a type of power transition operation in accordance with a first delay; receiving, in association with the link operation, an indication of a second delay associated with the host system performing the type of power transition operation; and updating, in response to receiving the indication of the second delay associated with the host system, the memory system to perform the type of power transition operation in accordance with a third delay that is greater than the second delay.
Aspect 2: The method, apparatus, or non-transitory computer-readable medium of aspect 1, further including operations, features, circuitry, logic, means, or instructions, or any combination thereof for storing an indication of the third delay in non-volatile memory of the memory system in response to updating the memory system to perform the type of power transition operation in accordance with the third delay.
Aspect 3: The method, apparatus, or non-transitory computer-readable medium of any of aspects 1 through 2, further including operations, features, circuitry, logic, means, or instructions, or any combination thereof for receiving, from the host system, a command to perform a power transition operation of the type of power transition operation; initiating the third delay in response to the command to perform the power transition operation; and transitioning, in response to receiving the command to perform the power transition operation, the memory system from a first power mode to a second power mode.
Aspect 4: The method, apparatus, or non-transitory computer-readable medium of aspect 3, where the second delay is in response to the command to perform the power transition operation.
Aspect 5: The method, apparatus, or non-transitory computer-readable medium of any of aspects 3 through 4, further including operations, features, circuitry, logic, means, or instructions, or any combination thereof for communicating, by the memory system, signaling with the host system after the third delay has elapsed.
Aspect 6: The method, apparatus, or non-transitory computer-readable medium of aspect 5, where signaling, from the host system, is received by the memory system after the second delay has elapsed.
Aspect 7: The method, apparatus, or non-transitory computer-readable medium of any of aspects 1 through 6, where the second delay is associated with a duration for which the host system refrains from communicating signaling with the memory system while performing the type of power transition operation, and where the third delay is associated with a duration for which the memory system refrains from communicating signaling with the host system while performing the type of power transition operation.
Aspect 8: The method, apparatus, or non-transitory computer-readable medium of any of aspects 1 through 7, where operations, features, circuitry, logic, means, or instructions, or any combination thereof for performing the link operation includes operations, features, circuitry, logic, means, or instructions, or any combination thereof for communicating signaling indicating operational parameters between the memory system and the host system, where receiving the indication of the second delay is in accordance with communicating the signaling.
Aspect 9: The method, apparatus, or non-transitory computer-readable medium of aspect 8, where operations, features, circuitry, logic, means, or instructions, or any combination thereof for performing the link operation includes operations, features, circuitry, logic, means, or instructions, or any combination thereof for establishing an initial connection between the memory system and the host system, where communicating the signaling is in response to establishing the initial connection.
Aspect 10: The method, apparatus, or non-transitory computer-readable medium of any of aspects 1 through 9, where the first delay is greater than or equal to the second delay and the third delay is smaller than the first delay.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
perform a link operation between the memory system and a host system, wherein, prior to the link operation, the memory system is configured to perform a type of power transition operation in accordance with a first delay;
receive, in association with the link operation, an indication of a second delay associated with the host system performing the type of power transition operation; and
update, in response to receiving the indication of the second delay associated with the host system, the memory system to perform the type of power transition operation in accordance with a third delay that is greater than the second delay.

2. The memory system of claim 1, wherein the processing circuitry is further configured to cause the memory system to:
store an indication of the third delay in non-volatile memory of the memory system in response to updating the memory system to perform the type of power transition operation in accordance with the third delay.

3. The memory system of claim 1, wherein the processing circuitry is further configured to cause the memory system to:
receive, from the host system, a command to perform a power transition operation of the type of power transition operation;
initiate the third delay in response to the command to perform the power transition operation; and
transition, in response to receiving the command to perform the power transition operation, the memory system from a first power mode to a second power mode.

4. The memory system of claim 3, wherein the second delay is in response to the command to perform the power transition operation.

5. The memory system of claim 3, wherein the processing circuitry is further configured to cause the memory system to:
communicate, by the memory system, signaling with the host system after the third delay has elapsed.

6. The memory system of claim 5, wherein the memory system is configured to receive signaling from the host system after the second delay has elapsed.

7. The memory system of claim 1, wherein:
the second delay is associated with a duration for which the host system is configured to refrain from communicating signaling with the memory system while performing the type of power transition operation; and
the third delay is associated with a duration for which the memory system is configured to refrain from communicating signaling with the host system while performing the type of power transition operation.

8. The memory system of claim 1, wherein, to perform the link operation, the processing circuitry is configured to cause the memory system to:
communicate signaling indicating operational parameters between the memory system and the host system, wherein the processing circuitry is configured to cause the memory system to receive the indication of the second delay in accordance with communicating the signaling.

9. The memory system of claim 8, wherein, to perform the link operation, the processing circuitry is configured to cause the memory system to:
establish an initial connection between the memory system and the host system, wherein the processing circuitry is configured to cause the memory system to communicate the signaling in response to establishing the initial connection.

10. The memory system of claim 1, wherein:
the first delay is greater than or equal to the second delay, and
the third delay is smaller than the first delay.

11. A non-transitory computer-readable medium storing code, the code comprising instructions executable by one or more processors to:
perform a link operation between a memory system and a host system, wherein, prior to the link operation, the memory system is configured to perform a type of power transition operation in accordance with a first delay;
receive, in association with the link operation, an indication of a second delay associated with the host system performing the type of power transition operation; and
update, in response to receiving the indication of the second delay associated with the host system, the memory system to perform the type of power transition operation in accordance with a third delay that is greater than the second delay.

12. The non-transitory computer-readable medium of claim 11, wherein the instructions are further executable by the one or more processors to:
store an indication of the third delay in non-volatile memory of the memory system in response to updating the memory system to perform the type of power transition operation in accordance with the third delay.

13. The non-transitory computer-readable medium of claim 11, wherein the instructions are further executable by the one or more processors to:
receive, from the host system, a command to perform a power transition operation of the type of power transition operation;
initiate the third delay in response to the command to perform the power transition operation; and
transition, in response to receiving the command to perform the power transition operation, the memory system from a first power mode to a second power mode.

14. The non-transitory computer-readable medium of claim 13, wherein the second delay is in response to the command to perform the power transition operation.

15. The non-transitory computer-readable medium of claim 13, wherein the instructions are further executable by the one or more processors to:
communicate, by the memory system, signaling with the host system after the third delay has elapsed.

16. The non-transitory computer-readable medium of claim 15, wherein the instructions are executable by the one or more processors to receive signaling from the host system after the second delay has elapsed.

17. The non-transitory computer-readable medium of claim 11, wherein:
the second delay is associated with a duration for which the host system is configured to refrain from communicating signaling with the memory system while performing the type of power transition operation; and
the third delay is associated with a duration for which the memory system is configured to refrain from communicating signaling with the host system while performing the type of power transition operation.

18. The non-transitory computer-readable medium of claim 11, wherein, to perform the link operation, the instructions are executable by the one or more processors to:
communicate signaling indicating operational parameters between the memory system and the host system, wherein the instructions are executable by the one or more processors to receive the indication of the second delay in accordance with communicating the signaling.

19. The non-transitory computer-readable medium of claim 18, wherein, to perform the link operation, the instructions are executable by the one or more processors to:
establish an initial connection between the memory system and the host system, wherein the instructions are executable by the one or more processors to communicate the signaling in response to establishing the initial connection.

20. The non-transitory computer-readable medium of claim 11, wherein:
the first delay is greater than or equal to the second delay, and
the third delay is smaller than the first delay.

21. A method by a memory system, comprising:
performing a link operation between the memory system and a host system, wherein, prior to the link operation, the memory system is configured to perform a type of power transition operation in accordance with a first delay;
receiving, in association with the link operation, an indication of a second delay associated with the host system performing the type of power transition operation; and
updating, in response to receiving the indication of the second delay associated with the host system, the memory system to perform the type of power transition operation in accordance with a third delay that is greater than the second delay.

22. The method of claim 21, further comprising:
storing an indication of the third delay in non-volatile memory of the memory system in response to updating the memory system to perform the type of power transition operation in accordance with the third delay.

23. The method of claim 21, further comprising:
receiving, from the host system, a command to perform a power transition operation of the type of power transition operation;
initiating the third delay in response to the command to perform the power transition operation; and
transitioning, in response to receiving the command to perform the power transition operation, the memory system from a first power mode to a second power mode.

24. The method of claim 23, wherein the second delay is in response to the command to perform the power transition operation.

25. The method of claim 23, further comprising:
communicating, by the memory system, signaling with the host system after the third delay has elapsed.
